(19) United States
(12) Patent Application Publication
(10) Pub. No.: US 2013/0277125 A1
(43) Pub. Date: Oct. 24, 2013

(54) Independent Front Suspension with Pitch Control for Track-Type Tractor

(71) Applicant: Todd Moser, Roanoak, IL (US)

(72) Inventor: Todd Moser, Roanoak, IL (US)

(73) Assignee: CATERPILLAR, INC., Peoria, IL (US)

(21) Appl. No.: 13/453,652

(22) Filed: Apr. 23, 2012

(51) Int. Cl. B62D 55/116; B62D 55/112; B62D 55/06

(52) U.S. Cl. 180/9.52; 180/9.5; 701/37

(57) ABSTRACT

A front suspension system for a track-type tractor includes a suspension saddle having first and second suspension arms pinned to the suspension saddle, the first and second suspension arms being connected to the machine tracks via first and second front idler respectively. Respective first and second hydraulic suspension assemblies support the first and second suspension arms, and a hydraulic suspension circuit fluidly links the first hydraulic suspension assembly to the second hydraulic suspension assembly such that a movement of either the first or the second hydraulic suspension assemblies causes an opposite movement of substantially the same magnitude in the other of the first and second hydraulic suspension assemblies, thereby allowing the first track and the second track of the track-type tractor to oscillate relative to one another.

### TECHNICAL FIELD OF THE DISCLOSURE

The present disclosure relates to track-type tractor suspension and, more particularly, relates to an independent front suspension with pitch control for a track-type tractor.

### BACKGROUND OF THE DISCLOSURE

Track-type machines have been used for many years in construction, mining, forestry, and other industries. Although the many benefits of such machines are well-recognized, certain drawbacks have not yet been solved. Of primary note, the suspension of a typical track-type tractor is stiff and can cause operator fatigue over long periods of use. The undercarriage of track-type machines utilizes track assemblies, rather than wheels, to provide ground-engaging propulsion. As such, the track-type drive system does not incorporate natural shock absorbing elements such as tires.

Moreover, the manner in which track-type machines are used precludes the use of traditional suspension schemes. In particular, a track-type machine is generally used to push or pull a cutting tool, scooping tool, or other surface treatment tool. As such, the level of the tool as the machine moves in such applications is often important, and a traditional suspension may introduce play into the system that would mar the resulting work product. For example, when a track-type tractor is used to push a blade across a surface to grade it or scrape it, the blade edge must remain at the desired level; a traditional suspension would allow the blade to dive when hard material is encountered while riding up over softer material.

Attempts have been made to design a front suspension for a track-type machine that provides operator comfort and machine stability without compromising work product quality. However, no such system has been successful in addressing the noted problems. For example, U.S. Pat. No. 7,192,034 discloses a track-driven articulated loader having an articulated chassis and front and rear A-frames. The system disclosed in the '034 patent includes a hydraulic suspension feature in both the front and the rear of the machine. However, the front suspension is configured to force both sides to move together, such that when one side moves up, the other side moves up as well. While this system allows strictly vertical movement of the front tracks in concert, it precludes any significant roll or oscillation. Indeed, the '034 patent specifically notes that the design of the system is intended to eliminate roll in the front suspension; see column 3 at lines 50-59 (“It is also desired to control vehicle roll position at this front axle . . . [the hydraulic layout] helps contribute to the roll stability”).

Thus, while the front suspension disclosed in the '034 patent does allow movement of the front tracks, the suspension design cannot accommodate any movement in the roll dimension. As such, there is a continuing need for improvement in the operational characteristics of track-type tractor suspension assemblies.

The present disclosure is directed to a track-type tractor front suspension assembly that addresses one or more of the problems set forth above. However, it should be appreciated that the solution of any particular problem is not a limitation on the scope of this disclosure nor of the attached claims except to the extent expressly noted. Additionally, the inclusion of any problem or solution in this Background section is not an indication that the problem or solution represents known prior art except as otherwise expressly noted.

### SUMMARY OF THE DISCLOSURE

In accordance with one aspect of the present disclosure, a front suspension system for a track-type tractor includes a suspension saddle having therein a first pivot point for receiving a first pivot pin and a second pivot point for receiving a second pivot pin, and a first suspension arm pinned to the suspension saddle via the first pivot pin and a second suspension arm pinned to the suspension saddle via the second pivot pin. The first suspension arm is connected to a front support of a first track of the track-type tractor and the second suspension arm is connected to a front support of a second track of the track-type tractor. A first hydraulic suspension assembly pivots the first suspension arm about the first pivot point and a second hydraulic suspension assembly pivots the second suspension arm about the second pivot point. A hydraulic suspension circuit fluidly links the first hydraulic suspension assembly to the second hydraulic suspension assembly such that a movement of either the first or the second hydraulic suspension assemblies causes an opposite movement of substantially the same magnitude in the other of the first and second hydraulic suspension assemblies, thereby allowing the first track and the second track of the track-type tractor to oscillate relative to one another.

In accordance with a further aspect of the present disclosure, a track-type tractor with oscillating front suspension is provided. The tractor includes a frame having a left and right member, a first track assembly on a first side of the tractor and a second track assembly on a second side of the tractor. The track assemblies are supported by respective first and second front idlers and respective first and second rear idlers. A hydraulic suspension connected to the tractor between the left and right frame members includes a first suspension arm pivotably connected to the hydraulic suspension and to the first front idler and a second suspension arm suspension arm pivotably connected to the hydraulic suspension and to the second front idler. First and second hydraulic suspension assemblies are positioned to pivot the suspension arms relative to the frame, and a hydraulic suspension circuit fluidly linking the first hydraulic suspension assembly to the second hydraulic suspension assembly allows movement of either the first or the second hydraulic suspension assemblies that causes an opposite movement of substantially the same magnitude in the other of the first and second hydraulic suspension assemblies, thus allowing the first track and the second track of the track-type tractor to oscillate relative to one another.

In accordance with yet another aspect of the present disclosure, a method is provided for controlling an oscillating hydraulic front suspension of a track-type tractor, wherein the tractor includes a hydraulic supply system and an undercarriage, and wherein a front height of the tractor over the undercarriage is set by the oscillating hydraulic front suspension. The method includes electrically actuating a three-position valve to selectively raise or lower the oscillating hydraulic front suspension, wherein the three-position valve supports a first position isolating the oscillating hydraulic front suspension from the hydraulic supply system, a second position linking the oscillating hydraulic front suspension to a drain of the hydraulic supply system, and a third position linking the oscillating hydraulic front suspension to a high pressure hydraulic source of the hydraulic supply system. After adjusting the hydraulic front suspension, the three-position valve is electrically actuated to the first position to fix the front height of the tractor over the undercarriage.

### BRIEF DESCRIPTION OF THE DRAWINGS

FIG. 1 is a pictorial representation of a side view of an exemplary track-type tractor within which various embodiments of the present disclosure may be implemented;

FIG. 2 is a cross-sectional view of a machine having an equalizer bar suspension configuration;

FIG. 3 is a cross-sectional view of a machine having an independent hydraulic suspension configuration in accordance with an implementation of the disclosure;

FIG. 4 is a schematic diagram of a matching hydraulic circuit in accordance with an implementation of the disclosure;

FIG. 5 is a schematic diagram of an alternative matching hydraulic circuit in accordance with an alternative implementation of the disclosure; and

FIG. 6 is a flow chart showing a process for actively managing machine pitch via a hydraulic suspension system in accordance with an implementation of the disclosure.

### DETAILED DESCRIPTION OF THE DISCLOSURE

The present disclosure provides an independent front suspension system for use in a track-type tractor, as well as a track-type tractor having such a suspension, whereby greater flexibility over rough ground is enabled. In further aspects of the disclosure, the front suspension and control system further provide energy absorption and machine pitch control.

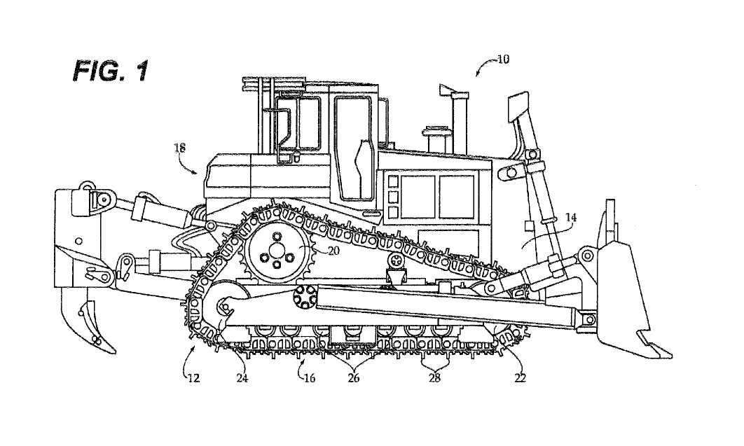

Referring now to FIG. 1, there is shown an example track-type tractor machine within which various embodiments of the present disclosure may be implemented. The illustrated machine 10 is a dozer, but it should be appreciated that the described system is applicable to other track-type tractor machines such as loaders, excavators, and other machines utilizing a track-type undercarriage 12, as described herein. As such, machine 10 may also be referenced herein as a track-type machine or track-type tractor.

The illustrated machine 10 includes a frame 14 having a track assembly 16 disposed at a first side 18 thereof, and a matching track assembly (not shown) disposed at a second, or opposite, side thereof. Together, the track assemblies engage the ground, or other surface, to propel the machine 10 during work operations.

The track assembly 16 in the illustrated example extends around a plurality of rolling elements such as a drive sprocket 20, a front idler 22, a rear idler 24, and a plurality of conventional track rollers, such as rollers 26. During typical operation of the undercarriage 12, the drive sprocket 20 is driven in a forward rotational direction to drive the track assembly 16 and, thus, machine 10 in a forward direction, and in a reverse rotational direction to drive the track assembly 16 and machine 10 in a reverse direction. Ground-engaging track shoes, such as track shoes 28, are attached to the track assembly 16 in the illustrated example for engaging the ground, or other surface, and propelling machine 10.

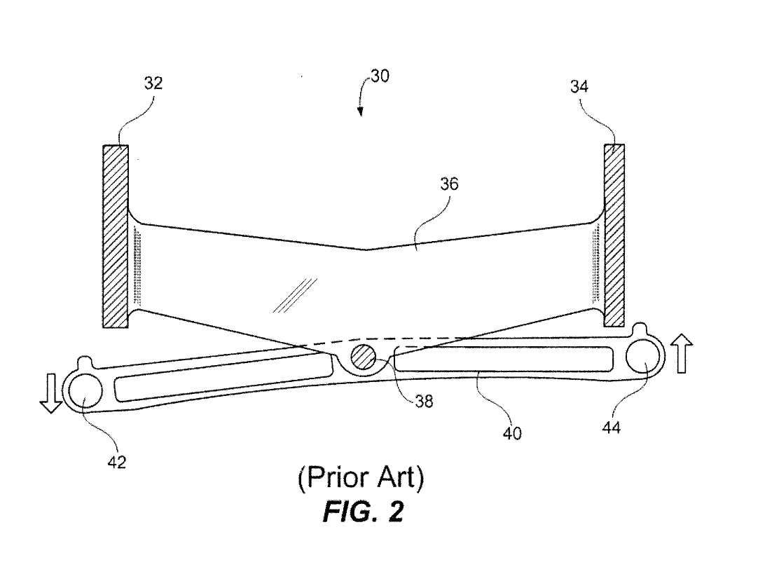

The internal suspension structure of the machine 10 is not visible in FIG. 1, but will be discussed with respect to other figures. Turning to FIG. 2, this figure shows a cross-sectional view of the frame of a traditional machine 10 taken in a vertical plane through the machine 10 at a position slightly in front of the front idler 22, omitting parts for clarity so that the suspension system may be clearly viewed and understood. In this illustration, a traditional track-type machine front suspension system 30 is shown. The left frame rail 32 and right frame 34 of the machine 10 are shown.

An equalizer bar saddle 36 is affixed between the left frame rail 32 and right frame 34 to bridge them structurally and to form a pivot point for an equalizer pivot pin 38 which supports an equalizer bar 40. The equalizer bar 40 is typically a cast and/or forged assembly, and has a pivot hole (not shown) for receiving the equalizer pivot pin 38 as well as a bushing cavity 42, 44 at each end for linking to the track system of the machine, e.g., via one or more front idlers.

In this configuration, the equalizer bar 40 bridges the machine frame to the front of the track system. Under conditions wherein one side of the equalizer bar 40 is driven upward, e.g., when a large stone is encountered on one side of the machine 10, the other side of the equalizer bar 40 is driven downward through pivot pin 38. While this arrangement allows rolling of the undercarriage to an extent, the suspension remains rigid in the vertical direction, providing no cushioning to the operator.

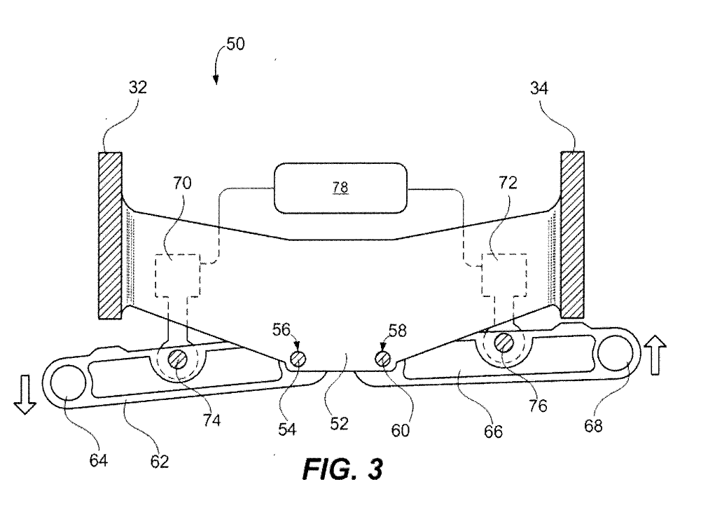

Turning now to FIG. 3, an improved track-type tractor front suspension system is shown in accordance with an aspect of the disclosed principles. The illustrated improved suspension system 50 is shown in cross-section, taken in a vertical plane through a machine such as machine 10, again at a position slightly in front of the front idler 22. The improved suspension system 50 includes a suspension saddle 52 bridging the left frame rail 32 to the right frame 34. The suspension saddle 52 provides a first pivot point 54 for a first suspension pivot pin 56 and a second pivot point 58 for a second suspension pivot pin 60.

A first suspension arm 62 is pinned via the first suspension pivot pin 56. The first suspension arm 62 incorporates a bushing cavity 64 for linking the first suspension arm 62 to a first track assembly, e.g., in the manner in which an equalizer bar is linked to a track assembly. Similarly a second suspension arm 66, which is pinned via the second suspension pivot pin 60, incorporates a bushing cavity 68 for linking the second suspension arm 66 to a second track assembly.

The first suspension arm 62 is pivotably linked to a first hydraulic suspension assembly 70 such that the first hydraulic suspension assembly 70 applies a torque, whether positive or reactive, to the first suspension arm 62. Similarly, the second suspension arm 66 is pivotably linked to a second hydraulic suspension assembly 72 which applies a torque to the second suspension arm 66. The first hydraulic suspension assembly 70 and second hydraulic suspension assembly 72 are fixed to the suspension saddle 52 by respective pivots, not shown in this view. The opposite end of the first hydraulic suspension assembly 70 and the second hydraulic suspension assembly 72 are pinned to the first suspension arm 62 and the second suspension arm 66 by a respective first supporting pivot pin 74 and second supporting pivot pin 76.

Each of the first hydraulic suspension assembly 70 and second hydraulic suspension assembly 72 comprises a hydraulic cylinder that moves in concert with the associated suspension arm. The hydraulic cylinders of the first hydraulic suspension assembly 70 and second hydraulic suspension assembly 72 are bridged together through a hydraulic matching circuit 78.

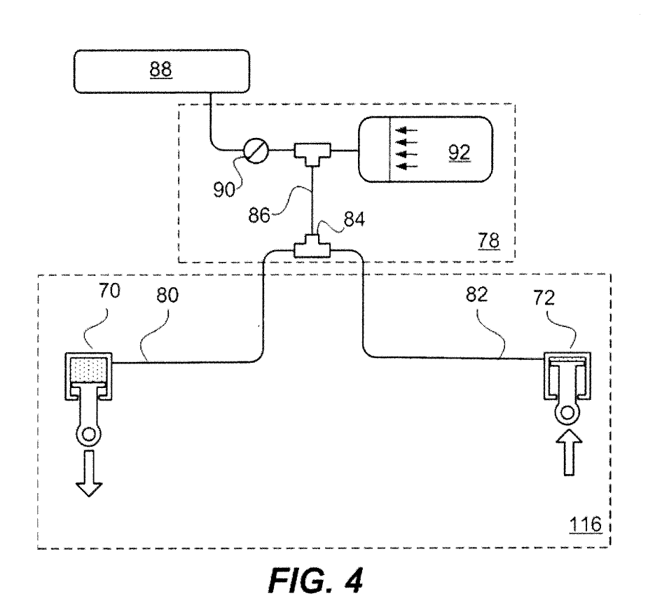

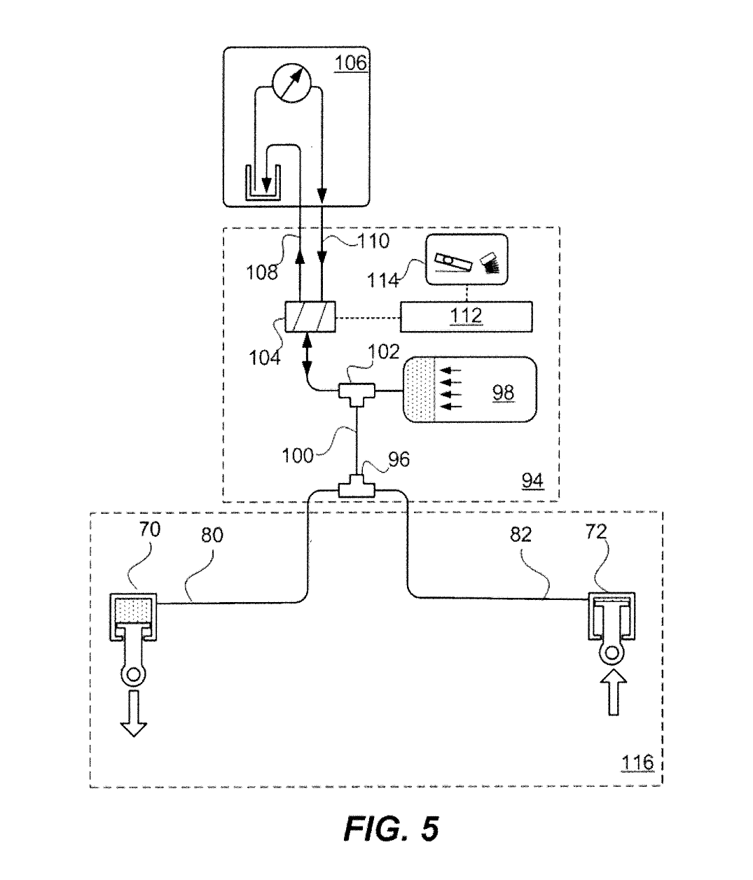

As will be discussed in greater detail below, the hydraulic matching circuit 78 allows the suspension arms 62, 66 to exhibit roll behavior, while also absorbing shock loads in an embodiment. In a further embodiment, the hydraulic matching circuit 78 also provides machine pitch control. Aspects and details of the hydraulic matching circuit 78 according to certain embodiments will be described by way of FIGS. 4-5.

Turning now to FIG. 4, this figure illustrates baseline embodiment of the hydraulic matching circuit 78. In the illustrated embodiment, the hydraulic matching circuit 78 includes a first hydraulic line 80 to the first hydraulic suspension assembly 70 and a second hydraulic line 82 to the second hydraulic suspension assembly 72. The first hydraulic line 80 and the second hydraulic line 82 are fluidly coupled via a t-coupling 84. The t-coupling 84 allows the introduction of hydraulic fluid to the suspension circuit 116 comprising the first hydraulic line 80 and the second hydraulic line 82, as well as the removal of hydraulic fluid from the suspension circuit 116 via an inlet line 86.

In an embodiment, the inlet line 86 is coupled directly or indirectly to a fluid source 88. The fluid source 88 may be a dedicated hydraulic pump system or alternatively may be the machine hydraulic system. A system valve 90 may be provided to isolate the inlet line 86 from the suspension circuit 116.

In a further aspect of the disclosed system, an accumulator 92 is optionally fluidly coupled to the first hydraulic line 80 and the second hydraulic line 82, e.g., via a t-coupling. In an embodiment, the accumulator 92 is a gas precharged accumulator containing a precharge of inert gas such as nitrogen. The placement and configuration of the accumulator 92 in the hydraulic matching circuit 78 allows it to absorb fluid from the first hydraulic line 80 and the second hydraulic line 82 when the pressure in those lines is high, e.g., when the front of one or both machine track assemblies encounters a sharp uplift in the underlying ground or other surface upon which the machine 10 is travelling. As such, the accumulator 92 may be referred to herein as a shock absorption device.

It will be appreciated that the function of the accumulator 92 may instead be served by an alternative accumulator type such as a spring-type accumulator, weighted accumulator, and so on. Whether a gas precharge, spring, or weight is used to supply a counter pressure in the accumulator 92, the medium may be precompressed or pretensioned to the degree desired to allow the accumulator 92 to retain an acceptable operating range when exposed to the typical pressure present in the first hydraulic line 80 and the second hydraulic line 82. While this pressure will vary with machine design and configuration, it will typically be equivalent to the combined weight on the front idlers of the undercarriage 12 divided by the combined pressure area of the pistons in the first hydraulic suspension assembly 70 and second hydraulic suspension assembly 72. During shock events, much higher pressures may be observed in the accumulator 92.

During operation of the machine 10 and of the hydraulic matching circuit 78, when the machine 10 is travelling over a smooth and level path, the pistons of the first hydraulic suspension assembly 70 and second hydraulic suspension assembly 72 are at approximately the same points in their range and the first suspension arm 62 and second suspension arm 66 are at approximately the same level beneath the suspension saddle 52. In this condition, the pressure in the first hydraulic line 80 and second hydraulic line 82 reflect only the weight of the machine at the front idlers as discussed above.

When the path being travelled changes grade gradually perpendicular to the direction of travel, e.g., when one side of the machine 10 encounters an edge of a pile while the other side remains on flat ground, the design of the undercarriage and hydraulic matching circuit 78 allow the front suspension to accommodate by rolling. In particular, as one suspension arm forces the piston of the associated hydraulic suspension assembly 70, 72 upward relative to the suspension saddle 52, the displaced fluid travels into the head end of the opposite hydraulic suspension assembly 70, 72.

This in turn forces the opposite suspension arm downward by an equal amount relative to the suspension saddle 52. When this occurs, the amount of rise in the front of the machine 10 is approximately equal to the average of the level under the left side of the machine 10 and the level under the right side of the machine front.

In the case of a gradual roll in terrain as discussed, the accumulator 92 is largely inactive. However, when more sudden changes in level on one or both sides of the machine are encountered, the accumulator 92 acts to buffer the sudden rise in hydraulic pressure in the first hydraulic line 80 and second hydraulic line 82, and thus prevents transmission of a sharp shaking or bump to the operator and the remainder of the machine 10. After the sharp rise is buffered, the system will return to equilibrium, that is, with the amount of rise in the front of the machine 10 being the average of the left and right side front terrain levels.

While the hydraulic matching circuit 78 shown in FIG. 4 thus accommodates temporary overall level changes in the suspension circuit 116 via the accumulator 92, the equilibrium state of the suspension circuit 116 is one of constant hydraulic volume, which yields zero sum displacements on average of the left and right sides of the front of the machine 10. However, in an alternative embodiment, in addition to the capabilities described above, an alternative matching circuit 94 is further configured to allow overall pitch shifting of the undercarriage relative to the machine 10.

Turning to FIG. 5, the alternative matching circuit 94 is shown in detail. As with the hydraulic matching circuit 78, the alternative matching circuit 94 is fluidly connected to the first hydraulic suspension assembly 70 and the second hydraulic suspension assembly 72 via the first hydraulic line 80 and the second hydraulic line 82 respectively. Within the alternative matching circuit 94, the suspension circuit 116 formed by the first hydraulic line 80 and the second hydraulic line 82 is tapped at t-connection 96 to an accumulator 98 via an inlet line 100. The inlet line 100 is also fluidly linked via t-connection 102 to a three-position valve 104, which may be a solenoid valve or other electrically controlled valve.

The three-position valve 104 is also fluidly connected to the machine hydraulic system 106. The connection of the machine hydraulic system inlet 108 and machine hydraulic system outlet 110 to the three-position valve 104 is such that the position of the three-position valve 104 is selectable to (1) isolate the machine hydraulic system 106 from the suspension circuit 116, (2) allow high pressure fluid from the machine hydraulic system 106 to enter the suspension circuit 116, raising the fluid volume in the suspension circuit 116 or (3) allow fluid to drain from the suspension circuit 116 into the machine hydraulic system 106, lowering the fluid volume in the suspension circuit 116.

An electronic controller 112 is electrically linked to the three-position valve 104, and is configured to control the three-position valve 104 based on sensor input from a sensor cluster 114 including one or more sensors, e.g., accelerometers, pitch sensors, etc., to detect a change in pitch of the machine 10. The controller 112 is implemented, in an embodiment, as a computing device incorporating one or more microcontrollers and/or microprocessors (collectively referred to herein as a “processor” or “digital processor”). The controller 112 operates by reading or loading computer-executable instructions, or code, from a nontransitory computer-readable medium such as a nonvolatile memory, a magnetic or optical disc memory, a flash drive, and so on. The controller 112 may execute the instructions in a time-shared manner, a multi-thread manner, or any other suitable execution technique. It will be appreciated that data used by the controller 112 in the execution of the computer-executable instructions may be stored and read out as well, or may be created in real time. The controller 112 has one or more interfaces to receive data and/or commands, and one or more outputs to output data and/or commands as it executes processes. The controller 112 may be an isolated controller but is alternatively implemented within another controller that also serves other machine functions.

In an embodiment, a detected pitch up in the front of the machine 10 of more than a predetermined tolerance value, such as 2 degrees, over a certain time interval, signals the controller 112 to set the three-position valve 104 so that fluid exits the suspension circuit 116 into the machine hydraulic system 106 via inlet machine hydraulic system 108.

Conversely, a detected pitch down in the front of the machine 10 of more than a predetermined tolerance value, such as 2 degrees, again over a certain time interval, signals the controller 112 to set the three-position valve 104 so that high pressure fluid enters the suspension circuit 116 from the machine hydraulic system 106 via outlet 110. In the event that neither a pitch up nor pitch down is detected, the controller 112 maintains the valve in a setting isolating the machine hydraulic system 106 and the suspension circuit 116 from one another.

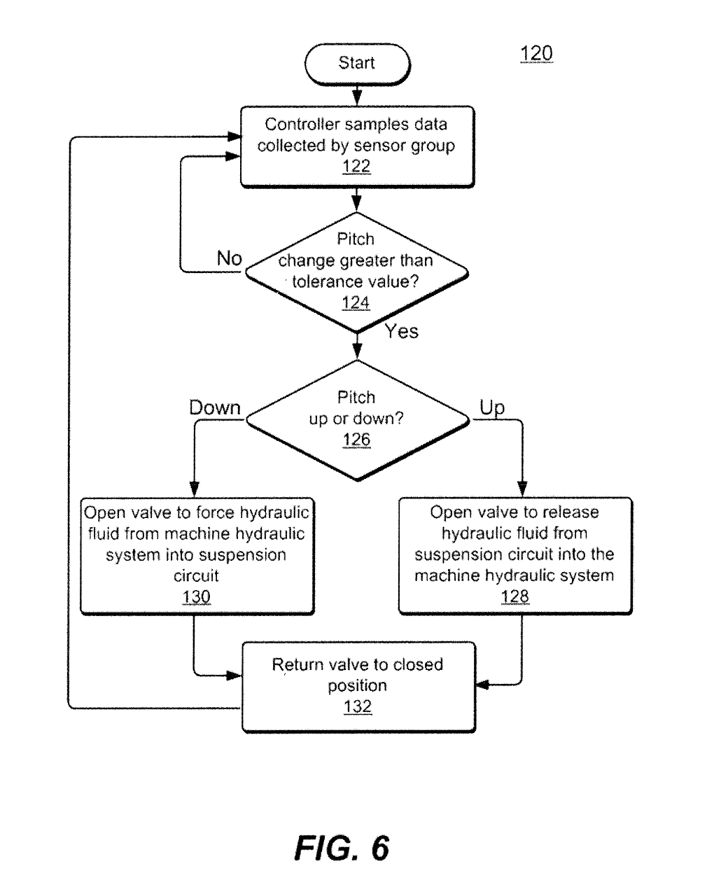

An example of the operation of the controller 112 to maintain the pitch of the machine 10 will be more fully understood from the flowchart of FIG. 6. In particular, FIG. 6 illustrates a process 120 for actively managing machine pitch via a hydraulic system such as that illustrated in FIG. 5. At stage 122 of the process 120, the controller 112 samples the data collected by the sensor group 114. This sampling may be by way of a periodic transmission from the sensor group 114 or may be executed as a periodic pole by the controller 112.

The controller 112 determines at stage 124 whether the collected sensor data represents a pitch change that falls outside of the predetermined tolerance value as mentioned above. If the collected sensor data does not represent a pitch change that falls outside of the predetermined tolerance value condition, the process 120 returns to stage 122.

If instead it is determined at stage 124 that the collected sensor data does represent a pitch change that falls outside of the predetermined tolerance value, the process 120 proceeds to stage 126, wherein the controller 112 determines whether the detected pitch is in the upward direction or the downward direction.

If the detected pitch is in the upward direction, the process 120 continues at stage 128, wherein the controller 112 sets the three-position valve 104 so that hydraulic fluid is released from the suspension circuit 116 into the machine hydraulic system 106 to counteract the detected pitch change. The duration for which the three-position valve 104 remains at this setting may be set based on the amount of pitch change or on the pitch acceleration. For example, a higher detected pitch rate may portend a larger impending pitch change, requiring a larger release of fluid from the suspension circuit 116. From stage 128, the process 120 flows to stage 132, wherein the controller 112 returns the three-position valve 104 to the closed position. Subsequent to stage 132, the process 120 returns to stage 122 to reevaluate data from the sensor cluster 114.

If the detected pitch is in the downward direction, the process 120 continues from stage 126 to stage 130, wherein the controller 112 sets the three-position valve 104 so that pressurized hydraulic fluid is forced into the suspension circuit 116 from the machine hydraulic system 106. This will counteract the downward pitch change by extending the first hydraulic suspension assembly 70 and second hydraulic suspension assembly 72 in proportion to the amount of additional fluid. As in the case of an upward pitch, the duration for which the three-position valve 104 remains open at this setting may be set based on the amount of pitch change or on the pitch acceleration. From stage 128, the process 120 flows to stage 132, wherein the controller 112 returns the three-position valve 104 to the closed position, and then proceeds back to stage 122 to reevaluate data from the sensor cluster 114.

### INDUSTRIAL APPLICABILITY

In general terms, the present disclosure sets forth a system and method for front suspension for a track-type tractor. The disclosed system and method allow for oscillatory behavior, as with an equalizer bar, but also allow a degree of shock absorption not present with an equalizer bar. Moreover, due to the hydraulic circuit linking the hydraulic assemblies of the suspension, a damping characteristic is also provided in the roll dimension.

In one embodiment, the system includes a hydraulic accumulator as a shock absorption device for both roll shocks and overall level change shocks. In a further embodiment, the hydraulic suspension circuit is selectively linkable to the drain or supply of the tractor hydraulic system. In this way, the overall height of the tractor front may be raised or lowered by increasing or decreasing the fluid volume in the suspension circuit. Moreover, abrupt pitch changes as the tractor travels over uneven ground may be countered by automatically detecting a pitch change and operating an electronic valve to raise or lower the front suspension to counter the detected pitch change.

It will be appreciated that the present disclosure provides a system and method for improved track-type tractor front suspension. While only certain embodiments have been set forth, alternatives and modifications will be apparent from the above description to those skilled in the art. These and other alternatives are considered equivalents and within the spirit and scope of this disclosure and the appended claims.

What is claimed is:

1. A front suspension system for a track-type tractor comprising:
a suspension saddle having therein a first pivot point for receiving a first pivot pin and a second pivot point for receiving a second pivot pin;
a first suspension arm pinned to the suspension saddle via the first pivot pin and a second suspension arm pinned to the suspension saddle via the second pivot pin, wherein the first suspension arm is connected to a front support of a first track of the track-type tractor and the second suspension arm is connected to a front support of a second track of the track-type tractor;
a first hydraulic suspension assembly positioned to apply a torque to the first suspension arm about the first pivot point and a second hydraulic suspension assembly positioned to apply a torque to the second suspension arm about the second pivot point; and
a hydraulic suspension circuit fluidly linking the first hydraulic suspension assembly to the second hydraulic suspension assembly such that a movement of either the first or the second hydraulic suspension assemblies causes an opposite movement of substantially the same magnitude in the other of the first and second hydraulic suspension assemblies, thereby allowing the first track and the second track of the track-type tractor to oscillate relative to one another.

2. The front suspension system for a track-type tractor in accordance with claim 1, wherein the hydraulic suspension circuit is a closed circuit of constant volume.

3. The front suspension system for a track-type tractor in accordance with claim 1, wherein the hydraulic suspension circuit is fluidly linked to a hydraulic matching circuit having a shock absorption device to temporarily buffer changes in fluid pressure in the hydraulic suspension circuit.

4. The front suspension system for a track-type tractor in accordance with claim 3, wherein the shock absorption device comprises a hydraulic accumulator.

5. The front suspension system for a track-type tractor in accordance with claim 4, wherein the hydraulic accumulator is a gas precharged accumulator.

6. The front suspension system for a track-type tractor in accordance with claim 3, wherein the hydraulic matching circuit comprises a controller electronically linked to an electrically actuatable valve, the electrically actuatable valve being located between the hydraulic suspension circuit and a machine hydraulic system.

7. The front suspension system for a track-type tractor in accordance with claim 6, wherein the electrically actuatable valve is configurable to any of a first position isolating the hydraulic suspension circuit from the machine hydraulic system, a second position linking the hydraulic suspension circuit to a drain of the machine hydraulic system, and a third position linking the hydraulic suspension circuit to a high pressure hydraulic source of the machine hydraulic system.

8. The front suspension system for a track-type tractor in accordance with claim 7, wherein the controller is configured to selectively actuate the electrically actuatable valve to adjust the height of the front of the track-type tractor by adjusting a fluid volume in the hydraulic suspension circuit.

9. The front suspension system for a track-type tractor in accordance with claim 8, further comprising a pitch sensor linked to the track-type tractor, and wherein the controller is further configured to detect a change in pitch of the track-type tractor via the pitch sensor and to selectively actuate the electrically actuatable valve to counter the detected change in pitch.

10. The front suspension system for a track-type tractor in accordance with claim 1, wherein the front support of the first track and the front support of the second track are front idlers of the tractor undercarriage.

11. A track-type tractor with oscillating front suspension, the tractor comprising:
a frame having a left and right member;
a first track assembly on a first side of the tractor and a second track assembly on a second side of the tractor, the first and second track assemblies being supported by respective first and second front idlers and respective first and second rear idlers;
a hydraulic suspension connected to the tractor between the left and right frame members, the hydraulic suspension comprising:
a first suspension arm pivotably connected to the hydraulic suspension and to the first front idler and a second suspension arm suspension arm pivotably connected to the hydraulic suspension and to the second front idler,
a first hydraulic suspension assembly positioned to apply a torque to the first suspension arm relative to the frame and a second hydraulic suspension assembly positioned to apply a torque to the second suspension arm relative to the frame; and
a hydraulic suspension circuit fluidly linking the first hydraulic suspension assembly to the second hydraulic suspension assembly such that a movement of either the first or the second hydraulic suspension assemblies causes an opposite movement of substantially the same magnitude in the other of the first and second hydraulic suspension assemblies, allowing the first track assembly and the second track assembly of the track-type tractor to oscillate relative to one another.

12. The track-type tractor with oscillating front suspension in accordance with claim 11, wherein the hydraulic suspension circuit is a closed circuit of constant volume.

13. The track-type tractor with oscillating front suspension in accordance with claim 11, wherein the hydraulic suspension circuit is fluidly linked to a hydraulic accumulator.

14. The track-type tractor with oscillating front suspension in accordance with claim 13, wherein the hydraulic accumulator is a gas precharged accumulator.

15. The track-type tractor with oscillating front suspension in accordance with claim 11, further comprising:
a machine hydraulic system;
an electrically actuatable valve between the hydraulic suspension circuit and the machine hydraulic system, the electrically actuatable valve being configurable to any of a first position isolating the hydraulic suspension circuit from the machine hydraulic system, a second position linking the hydraulic suspension circuit to a drain of the machine hydraulic system, and a third position linking the hydraulic suspension circuit to a high pressure hydraulic source of the machine hydraulic system; and
an electronic controller linked to the electrically actuatable valve to select one of the first, second and third positions.

16. The track-type tractor with oscillating front suspension in accordance with claim 15, wherein the electronic controller is configured to selectively actuate the electrically actuatable valve to adjust a height of the front idlers by adjusting a fluid volume in the hydraulic suspension circuit.

17. The track-type tractor with oscillating front suspension in accordance with claim 12, further comprising a pitch sensor for detecting a change in pitch of the tractor, and wherein the controller is further configured to selectively actuate the electrically actuatable valve to counter the detected change in pitch.

18. A method for controlling an oscillating hydraulic front suspension of a track-type tractor, wherein the tractor includes a machine hydraulic system and an undercarriage, wherein a front height of the tractor over the undercarriage is set by the oscillating hydraulic front suspension, the method comprising:
electrically actuating a three-position valve to selectively raise or lower the oscillating hydraulic front suspension, wherein the three-position valve provides a first position isolating the oscillating hydraulic front suspension from the machine hydraulic system, a second position linking the oscillating hydraulic front suspension to a drain of the machine hydraulic system, and a third position linking the oscillating hydraulic front suspension to a high pressure hydraulic source of the machine hydraulic system; and
after electrically actuating the three-position valve to selectively raise or lower the oscillating hydraulic front suspension, electrically actuating the three-position valve to the first position to fix the front height of the tractor over the undercarriage.

19. The method for controlling an oscillating hydraulic front suspension of a track-type tractor in accordance with claim 18, further comprising detecting a pitch change in the tractor, wherein electrically actuating the three-position valve to selectively raise or lower the oscillating hydraulic front suspension comprises actuating the three-position valve to counter the detected pitch change in the tractor.

20. The method for controlling an oscillating hydraulic front suspension of a track-type tractor in accordance with claim 19, wherein actuating the three-position valve to counter the detected pitch change in the tractor includes actuating the three-position valve to the second position when the detected pitch change in the tractor is an upward pitch, and actuating the three-position valve to the third position when the detected pitch change in the tractor is a downward pitch.
